(19) United States
(12) Patent Application Publication
(10) Pub. No.: US 2025/0246783 A1
(43) Pub. Date: Jul. 31, 2025

(54) BATTERY MODULE PROTECTIVE STRUCTURE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi, Aichi-ken (JP)

(21) Appl. No.: 18/966,302

(22) Filed: Dec. 3, 2024

(30) Foreign Application Priority Data
Jan. 30, 2024 (JP) 2024-012089

(51) Int. Cl. H01M 50/588; H01M 50/264; H01M 50/507; H01M 50/569; H01M 50/59

(52) U.S. Cl. CPC H01M 50/588; H01M 50/264; H01M 50/507; H01M 50/569; H01M 50/59

(57) ABSTRACT

A battery module protective structure includes: a plurality of battery modules including a battery stack in which a plurality of battery cells is stacked; a first conductive connecting member, having an inclined portion inclined in a first direction intersecting a horizontal direction, for electrically connecting between the battery modules; and a second conductive connecting member, which is more separated from the battery modules than the first conductive connecting member, is at least partially overlapped with the inclined portion when projected in the horizontal direction, and is electrically connected to a total positive terminal or a total negative terminal of the battery module.

### CROSS-REFERENCE TO RELATED APPLICATION(S)

The present application claims priority to and incorporates by reference the entire contents of Japanese Patent Application No. 2024-012089 filed in Japan on Jan. 30, 2024.

### BACKGROUND

The present disclosure relates to battery module protective structures.

Japanese Laid-open Patent Publication No. 2020-205198 discloses a bus bar for electrically connecting a plurality of battery modules.

### SUMMARY

There is a need for providing a battery module protective structure that prevents a short circuit when an external force is input.

According to an embodiment, A battery module protective structure includes: a plurality of battery modules including a battery stack in which a plurality of battery cells is stacked; a first conductive connecting member, having an inclined portion inclined in a first direction intersecting a horizontal direction, for electrically connecting between the battery modules; and a second conductive connecting member, which is more separated from the battery modules than the first conductive connecting member, is at least partially overlapped with the inclined portion when projected in the horizontal direction, and is electrically connected to a total positive terminal or a total negative terminal of the battery module.

### BRIEF DESCRIPTION OF THE DRAWINGS

FIG. 1 is a top view of a battery module protective structure according to an embodiment;

FIG. 2 is a cross-sectional view corresponding to A-A line of the battery module protective structure in FIG. 1;

FIG. 3 is an enlarged perspective view of the battery module; and

FIG. 4 is a diagram illustrating a movement of each part when an external force due to a side protrusion is input.

### DETAILED DESCRIPTION

In the related art, in a case where the inter-stack bus bar for electrically connecting the battery modules and the total+bus bar which is electrically connected to the total positive terminal (or total negative terminal) of the battery module are arranged so as to overlap by projecting in the horizontal direction, when the external force due to the side protrusion or the like of the vehicle equipped with the battery module is input, the inter-stack bus bar and the total+bus bar there is a case where a short circuit occurs by interference.

The battery module protective structure according to an embodiment of the present disclosure will be described with reference to the drawings. In addition, components in the following embodiments include those which can be substituted and easily by those skilled in the art, or those which are substantially the same.

### Embodiment

### Configuration of the Battery Module Protective Structure

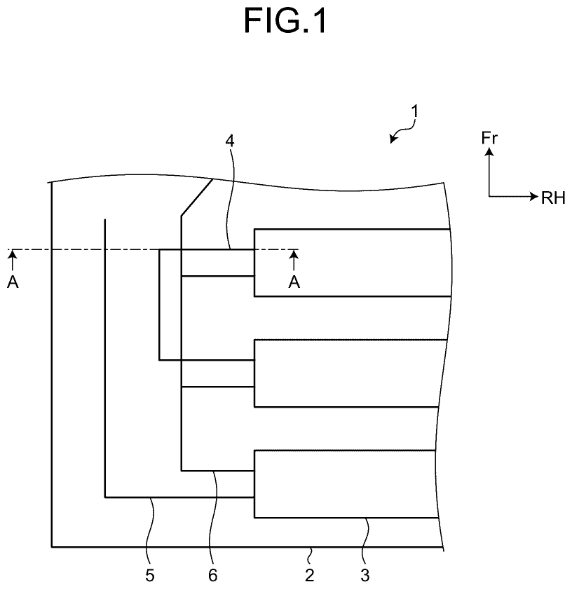

FIG. 1 is a top view of a battery module protective structure according to an embodiment. In FIG. 1, Fr corresponds to the front of the vehicle in which the battery module protection structure 1 is mounted, and RH corresponds to the right side of the vehicle in which the battery module protection structure 1 is mounted. The battery module protective structure 1 includes a battery case 2, a plurality of battery modules 3, an inter-stack bus bar 4 as a first conductive connecting member, a total+bus bar 5 as a second conductive connecting member, and a voltage detection line 6.

The battery module protective structure 1 is, for example, a structure for protecting the battery module 3 to be mounted on the vehicle.

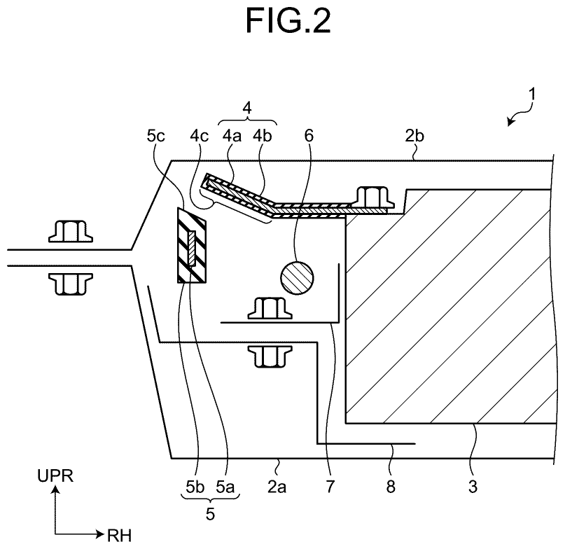

FIG. 2 is a cross-sectional view corresponding to A-A line of the battery module protective structure illustrated in FIG. 1. In FIG. 2, UPR corresponds to above the vehicle on which the battery module protection structure 1 is mounted, and RH corresponds to the right side of the vehicle on which the battery module protection structure 1 is mounted. The battery module protective structure 1 includes a stack bracket 7 and a linforce 8.

The battery case 2 includes a lower case 2a located below, an upper case 2b located above. The lower case 2a and the upper case 2b are fixed to each other by screws or the like.

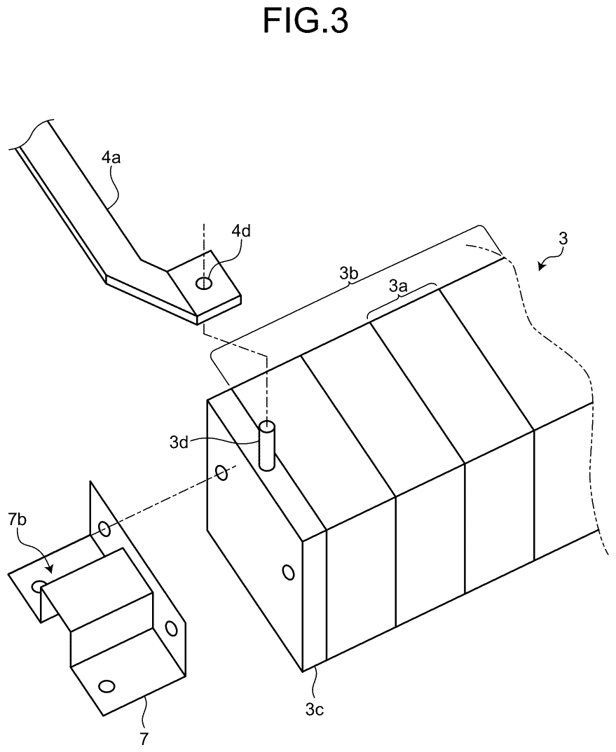

FIG. 3 is an enlarged perspective view of the battery module. As illustrated in FIG. 3, the battery module 3 has a battery stack 3b in which a plurality of battery cell 3a are stacked, an end plate 3c located at an end portion in the stacking direction, and a terminal 3d provided at an end portion.

Returning to FIG. 2, the inter-stack bus bar 4 includes a conductive member 4a made of a material having conductivity, made of a material having insulating property, and a protective member 4b covering the conductive member 4a, electrically connecting between the battery modules 3. Further, inter-stack bus bar 4 has an inclined portion 4c which is inclined in the first direction intersecting the horizontal direction (lateral direction in FIG. 2). Further, as illustrated in FIG. 3, the end portion of the conductive member 4a, a through-hole 4d in which the terminal 3d is inserted is formed.

The total+bus bar 5 includes a conductive member 5a, made of a material having conductivity, and a protective member 5b, made of a material having an insulating property, covering the conductive member 5a, and is electrically connected to the total positive terminal of the battery module 3. The second conductive connecting member may be a total-bus bar which is electrically connected to the total negative terminal. Further, the total+bus bar 5 is spaced apart from the cell module 3 than the inter-stack bus bar 4, at least partially overlaps the inclined portion 4c is projected horizontally. Further, the total+bus bar 5 overlaps with the tipping portion 4c is projected in the horizontal direction, the inclined surface 5c which is inclined in the first direction may be formed.

The voltage detection line 6 detects the voltage of the battery module 3.

The stack bracket 7 fixes the battery module 3 to the battery case 2 (lower case 2a) by interposing a linkage 8.

The linforce 8 is fixed by the stack bracket 7 and the bolt, to secure the stack bracket 7 to the battery case 2 (lower case 2a). The stack bracket 7 is fixed to the linforce 8 by bolts or the like.

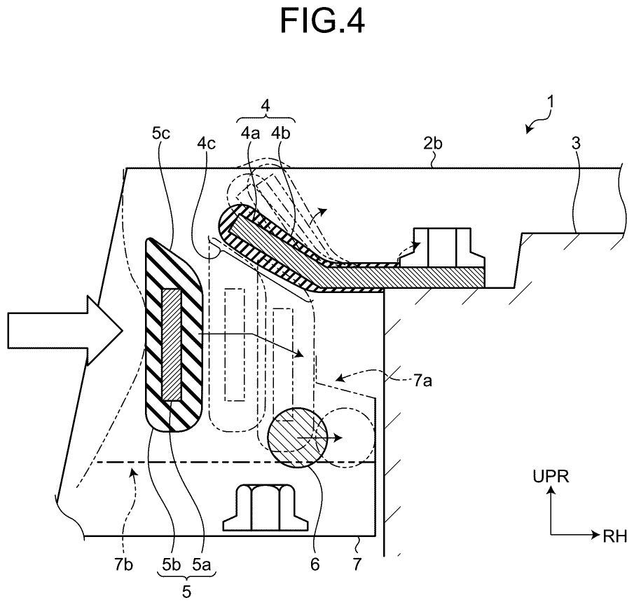

FIG. 4 is a diagram illustrating a movement of each part when the external force due to the side protrusion is input. FIG. 4 represents the same cross-section as FIG. 2, and it is assumed that the external force due to the side protrusion from the left side to the vehicle in which the battery module protective structure 1 is mounted is input. When an external force is input, the battery case 2 is deformed inward, the total+bus bar 5 is pushed to the battery module 3 side. Then, the inclined surface 5c of the total+buss bar 5, and the inclined portion 4c of the inter-stack buss bar 4 abuts, the force downward is applied to the total+buss bar 5, the force upward is applied to the inter-stack buss bar 4. As a result, since the inter-stack bus bar 4 bends upward, the inter-stack bus bar 4 is prevented from breaking and short-circuiting occurs.

Further, by keeping the strength of the protective member 4b higher than the strength of the upper case 2b, it is possible to prevent the upper case 2b from being deformed and the protective member 4b is damaged short circuit occurs when the protective member 4b and the upper case 2b contacts.

Further, the stack bracket 7 may have an overhanging portion 7a which projects from the battery module 3 side to the total+bus bar 5 side. The inclined surface 5c of the total+bus bar 5, and the inclined portion 4c of the inter-stack bus bar 4 is in contact, the total+bus bar 5 that has slipped below the inter-stack bus bar 4 is in contact with the overhanging portion 7a. Due to this, it is possible to prevent the inter-stack bus bar 4 from being bent too much (e.g., 90 degrees or more) and damaged. Further, it is possible to prevent the voltage detecting line 6 from being sandwiched by the total+bus bar 5.

The stack bracket 7 may have a convex part 7b protruding upward above the height of the bolts for fixing the stack bracket 7 and the linforce 8. The convex part 7b protrudes in a U-shape as illustrated in FIG. 3, for example. Since the stack bracket 7 has a convex part 7b, it is possible to prevent the total+bus bar 5 and the voltage detecting line 6 at the time of side protrusion from being damaged when contacts with the volts.

Further effects and variations can be readily derived by one skilled in the art. Thus, the broader aspects of the disclosure are not limited to the particular details and representative embodiments described and represented above. Accordingly, various modifications are possible without departing from the spirit or scope of the overall inventive concept defined by the appended claims and their equivalents.

According to the present disclosure, it is possible to realize a battery module protective structure that prevents a short circuit from occurring when an external force is input.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery module protective structure comprising:
a plurality of battery modules including a battery stack in which a plurality of battery cells is stacked;
a first conductive connecting member, having an inclined portion inclined in a first direction intersecting a horizontal direction, for electrically connecting between the battery modules; and
a second conductive connecting member, which is more separated from the battery modules than the first conductive connecting member, is at least partially overlapped with the inclined portion when projected in the horizontal direction, and is electrically connected to a total positive terminal or a total negative terminal of the battery module.

2. The battery module protective structure according to claim 1, wherein the second conductive connecting member overlaps the inclined portion when projected in the horizontal direction, and
an inclined surface inclined in the first direction is formed on the second conductive connecting member.

3. The battery module protective structure according to claim 1, further comprising:
a voltage detection line for detecting a voltage of the battery modules; and
a stack bracket for fixing the battery modules to a battery case.

4. The battery module protective structure according to claim 3, wherein
the stack bracket has an overhanging portion which projects from a side of the battery modules to a side of the second conductive connecting member.

5. The battery module protective structure according to claim 3, further comprising:
a linforce, fixed to the stack bracket with a bolt, for fixing the stack bracket to the battery case, wherein
the stack bracket has a convex part projecting upward above a height of the bolt.
